(19) United States
(12) Patent Application Publication
(10) Pub. No.: US 2013/0148740 A1
(43) Pub. Date: Jun. 13, 2013

(54) METHOD AND APPARATUS FOR PROCESSING PARTIAL VIDEO FRAME DATA

(71) Applicant: Anil R. Samanta Singhar, San Diego, CA (US)

(72) Inventor: Anil R. Samanta Singhar, San Diego, CA (US)

(73) Assignee: QUALCOMM Incorporated, San Diego, CA (US)

(21) Appl. No.: 13/315,825

(22) Filed: Dec. 9, 2011

(51) Int. Cl. H04N 7/26

(52) U.S. Cl. 375/240.24; 375/E07.2

(57) ABSTRACT

Methods and apparatus for processing a partial video frame are provided. In an exemplary method, first pixel data for a first video frame is received. Second pixel data for a second video frame that is subsequent to the first video frame is also received. Macro-blocks of pixels from the first and second pixel data that have changed between the first and second video frames are identified. Only the changed macro-blocks of pixels along with sufficient meta-data are transmitted to a video receiver. At least one of cursor pointer video data, mouse pointer video data, and overlay video data can be composited with the changed macro-blocks of pixels.

### FIELD OF DISCLOSURE

This disclosure relates generally to electronics, and more specifically, but not exclusively, to apparatus and methods for processing digital video,

### BACKGROUND

Conventional methods and apparatus for transmitting and receiving video data over digital channels and/or links comply with standardized video data interface protocols such as Digital Visual Interface (DVI), High-Definition Multimedia interface (HDMI), DisplayPort, etc. The conventional methods and apparatus transmit an entire video frame at every vertical synchronization pulse (Vsync), regardless of whether the frame being transmitted is different from the previous frame. Thus, conventional methods and apparatus use video data channel bandwidth and power inefficiently when two temporally consecutive video frames are either not different at all, or only differ very little.

Accordingly, there are long-felt industry needs for methods and apparatus that improve upon conventional methods and apparatus.

### SUMMARY

This summary provides a basic understanding of some aspects of the present teachings. This summary is not exhaustive in detail, and is neither intended to identify all critical features, nor intended to limit the scope of the claims.

Exemplary methods and apparatus for processing digital video are provided. An exemplary method includes receiving first pixel data for a first video frame, receiving second pixel data for a second video frame that is subsequent to the first video frame, identifying macro-blocks of pixels from the first and second pixel data that have changed between the first and second video frames, and transmitting only the changed. macro-blocks of pixels. The method can include transmitting a matrix of one-bit flags that indicate which macro-blocks have changed since last frame and other meta-data to help the receiver target device reconstruct the frame, where multiple pixel locations in the first and second pixel data have different pixel data values at respective pixel locations. The method can further include compositing at least one of cursor pointer video data, mouse pointer video data, and overlay video data with the changed macro-blocks of pixels. The method can include using operating system services to determine if the second video frame includes video with high motion content. The method can also include transmitting a portion of a display surface containing video with high motion content by not decompressing such video and transmitting it in original compressed form. The method can include requesting a target device to provide decompression and composition capabilities.

An exemplary method includes steps for receiving first pixel data for a first video frame, steps for receiving second pixel data for a second video frame that is subsequent to the first video frame, steps for identifying macro-blocks of pixels from the first and second pixel data that have changed between the first and second video frames, and steps for transmitting only the changed macro-blocks of pixels. The method can include steps for transmitting a matrix of one-bit flags that indicate which macro-blocks have changed. since last frame and other meta-data to help the receiver target device reconstruct the frame, where multiple pixel locations in the first and second pixel data have different pixel data values at respective pixel locations. The method can further include steps for compositing at least one of cursor pointer video data, mouse pointer video data, and overlay video data with the changed macro-blocks of pixels. The method can include steps for using operating system services to determine if the second video frame includes video with high motion content. The method can also include steps for transmitting a portion of a display surface containing video with high motion content by not decompressing such video and transmitting it in original compressed form. The method can include steps for requesting a target device to provide decompression and composition capabilities.

In a further example, provided is a non-transitory computer-readable medium, comprising instructions stored thereon that, if executed by a processor, cause the processor to execute at least a part of the aforementioned methods. The non-transitory computer-readable medium can be integrated with at least one of an HDMI-compatible device, a DisplayPort compatible device, a mobile device, a set-top box, a television, a computer, a computer video card., a game console, DVD player, a satellite receiver, a monitor, a display headset, a video repeater, a video camera, a home theatre receiver, and a video switching device.

In another example, provided is an apparatus configured to process digital video. The apparatus includes means for receiving first pixel data for a first video frame, means for receiving second pixel data for a second video frame that is subsequent to the first video frame, means for identifying macro-blocks of pixels from the first and second pixel data that have changed between the first and second video frames, and means for transmitting only the changed macro-blocks of pixels. The apparatus can also include means for transmitting a matrix of one-bit flags that indicate which macro-blocks have changed since last frame and other meta-data as required to re-construct the frame, where multiple pixel locations in the first and second pixel data have different pixel data values at respective pixel locations. The apparatus can also include means for compositing at least one of cursor pointer video data, mouse pointer video data, and overlay video data with the changed macro-blocks of pixels. The apparatus can further include means for using operating system services to determine if the second video frame includes video with high motion content. The apparatus can include means for separating and transmitting a portion of a display surface containing video with high motion content by not decompressing such video and transmitting it in original compressed form. The apparatus can include means for requesting a target device to provide decompression and composition capabilities.

At least a part of the apparatus can be integrated in a semiconductor die. Further, at least a part of the apparatus can be integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device. In a further example, provided is a non-transitory computer-readable medium, comprising instructions stored thereon that, if executed by a lithographic device, cause the lithographic device to fabricate at least a part of the apparatus.

In another example, provided is an apparatus configured to process digital video. The apparatus includes a processor configured to receive first pixel data for a first video frame, receive second pixel data for a second video frame that is subsequent to the first video frame, identify macro-blocks of pixels from the first and second pixel data that have changed between the first and second video frames, and transmit only the changed macro-blocks of pixels. The processor can also be configured to transmit a matrix of one-hit flags that indicate which macro-blocks have changed since last frame and other meta-data required to re-construct the frame, where multiple pixel locations in the first and second pixel data have different pixel data values at respective pixel locations. The processor can also be configured to composite at least one of cursor pointer video data, mouse pointer video data, and overlay video data with the changed macro-blocks of pixels. The processor can also be configured to use operating system services to determine if the second video frame includes video with high motion content. The processor can also be configured to transmit a portion of a display surface including high motion content by not decompressing the second video frame and transmitting the second video frame. The processor can also be configured to request a target device to provide decompression and composition capabilities.

At least a part of the apparatus can be integrated in a semiconductor die. Further, at least a part of the apparatus can be integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device. In a further example, provided is a non-transitory computer-readable medium, comprising instructions stored thereon that, if executed by a lithographic device, cause the lithographic device to fabricate at least a part of the apparatus.

Additional exemplary methods and apparatus for processing digital video are also provided. An exemplary method includes receiving a changed macro-block from a source device, retrieving stored video frame data from a buffer, overwriting the stored video frame data with the changed macro-block to create a current video frame, and outputting the current video frame.

Another exemplary method includes steps for receiving a changed macro-block from a source device, steps for retrieving stored video frame data from a buffer, steps for overwriting the stored video frame data with the changed macro-block to create a current video frame, and steps for outputting the current video frame.

In a further example, provided is a non-transitory computer-readable medium, comprising instructions stored thereon that, if executed by a processor, cause the processor to execute at least a part of the aforementioned method. The non-transitory computer-readable medium can be integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

In another example, provided is an apparatus configured to process digital video. The apparatus includes means for receiving a changed macro-block from a source device, means for retrieving stored video frame data from a buffer, means for overwriting the stored video frame data with the changed macro-block to create a current video frame, and means for outputting the current video frame.

At least a part of the apparatus can be integrated in a semiconductor die. Further, at least a part of the apparatus can be integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device. In a further example, provided is a non-transitory computer-readable medium, comprising instructions stored thereon that, if executed by a lithographic device, cause the lithographic device to fabricate at least a part of the apparatus.

In another example, provided is an apparatus configured to save power. The apparatus includes a processor configured to receive a changed macro-block from a source device, retrieve stored video frame data from a buffer, overwrite the stored video frame data with the changed macro-block to create a current video frame, and output the current video frame.

At least a part of the apparatus can be integrated in a semiconductor die. Further, at least a part of the apparatus can be integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device. In a further example, provided is a non-transitory computer-readable medium, comprising instructions stored thereon that, if executed by a lithographic device, cause the lithographic device to fabricate at least a part of the apparatus.

The foregoing broadly outlines some of the features and technical advantages of the present techniques in order that the detailed description and drawings can be better understood. Additional features and advantages are also described in the detailed description. The conception and disclosed embodiments can be readily utilized as a basis for modifying or designing other structures for carrying out the same purposes of the present techniques. Such equivalent constructions do not depart from the technology of the techniques as set forth in the claims. The novel features that are characteristic of the techniques, together with further objects and advantages, are better understood from the detailed, description and the accompanying figures. Each of the drawings is provided for the purpose of illustration and description only, and does not limit the present techniques.

### BRIEF DESCRIPTION OF THE DRAWINGS

The accompanying drawings are presented to describe examples of the present teachings, and are not limiting.

FIGS. 1A-1B depict exemplary subsequent video frames.

FIGS. 2A-2B depict exemplary video pixel data.

FIG. 3 depicts the time for which the transmitter has to stay “ON” when transmitting video data.

FIG. 4 depicts an exemplary depicts an exemplary communication system in which an embodiment of the disclosure may be advantageously employed.

FIG. 5 depicts an exemplary video source device for processing a partial frame.

FIGS. 6A-D depict an exemplary method for processing partial video frame data.

FIG. 7 depicts another exemplary method for processing partial video frame data.

FIG. 8 depicts an exemplary video target device for processing a partial frame.

FIG. 9 depicts an exemplary method for processing partial video frame data.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Introduction

Methods and apparatus for processing a partial video frame are provided. In an exemplary method, first pixel data for a first video frame is received. Second pixel data for a second video frame that is subsequent to the first video frame is also received. Macro-blocks of pixels from the first and second pixel data that have changed between the first and second video frames are identified. Only the changed macro-blocks of pixels along with corresponding meta-data, cursor and mouse data and overlay data are transmitted to a video receiver. At least one of cursor pointer video data, mouse pointer video data, and overlay video data can be composited with the changed macro-blocks of pixels.

An advantage provided by the exemplary apparatuses and methods disclosed herein is a reduction in power consumption over conventional devices. Another advantage is a reduction in video data channel bandwidth used to transport the video.

Examples of the current techniques are disclosed in this application's text and drawings. The examples advantageously address the long-felt industry needs, as well as other previously unidentified needs, and mitigate shortcomings of the conventional methods and apparatus. Alternate embodiments can be devised without departing from the scope of the invention. Additionally, conventional elements of the current techniques may not be described in detail, or may be omitted, to avoid obscuring aspects of the current techniques.

The word “exemplary” is used herein to mean “serving as an example, instance, or illustration.” Any embodiment described as “exemplary” is not necessarily to be construed as preferred or advantageous over other embodiments. Likewise, the term “embodiments of the invention” does not require that all embodiments of the invention include the discussed feature, advantage, or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures.

It should be noted that the terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As employed herein two elements can be considered to be “connected” or “coupled” together by the use of one or more wires, cables, and/or printed electrical connections, as well as by the use of electromagnetic energy, such as electromagnetic energy having wavelengths in the radio frequency region, the microwave region and/or the optical (both visible and invisible) region, as several non-limiting and non-exhaustive examples.

It should be understood that the term “signal” can include any signal such as a data signal, audio signal, video signal, multimedia signal. Information and signals can be represented using any of a variety of different technologies and techniques. For example, data, instructions, process step, commands, information, signals, bits, symbols, and chips that can be referenced throughout this description can be represented by voltages, currents, electromagnetic waves, magnetic fields or particles, optical fields or particles, and/or any combination thereof. The video inputs and/or outputs (e.g., signals) described herein can he received and/or transmitted over a transmission medium. For example, if the video inputs and/or outputs are transmitted from a website, server, or other video-compatible device using a coaxial cable, fiber optic cable, twisted pair, digital subscriber line (DSL), or wireless technologies such as infrared. radio, and/or microwave, then the coaxial cable, fiber optic cable, twisted pair, DSL, or wireless technologies such as infrared, radio, and microwave are included in the definition of transmission medium. Examples of video-compatible devices include, and are not limited to, an HDMI-compatible device, a DisplayPort-compatible device, a mobile device, a set-top box, a television, a computer, a computer video card, a game console, DVD player, a satellite receiver, a monitor, a display headset, a video repeater, a video camera, a home theatre receiver, and a video switching device. In examples, the apparatus described herein can be integrated with a video-compatible device.

It should be understood that any reference to an element herein using a designation such as “first,” “second,” and so forth does not generally limit the quantity or order of those elements. Rather, these designations can be used herein as a convenient method of distinguishing between two or more elements or instances of an element. Thus, a reference to first and second elements does not mean that only two elements can be employed, or that the first element must necessarily precede the second element. Also, unless stated otherwise, a set of elements can comprise one or more elements. In addition, terminology of the form “at least one of: A, B, or C” used in the description or the claims means “A or B or C or any combination of these elements.”

The terminology used herein is for the purpose of describing particular embodiments only and is not intended to be limiting. As used herein, the singular forms “a,” “an,” and “the” are intended, to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the following description, certain terminology is used to describe certain features. The term “mobile device” includes, but is not limited to, a mobile phone, a mobile communication device, personal digital assistant, mobile palm-held computer, a wireless device, and/or other types of portable electronic devices typically carried by a person and/or having some form of communication capabilities (e.g., wireless, infrared, short-range radio, etc.).

### DESCRIPTION OF THE FIGURES

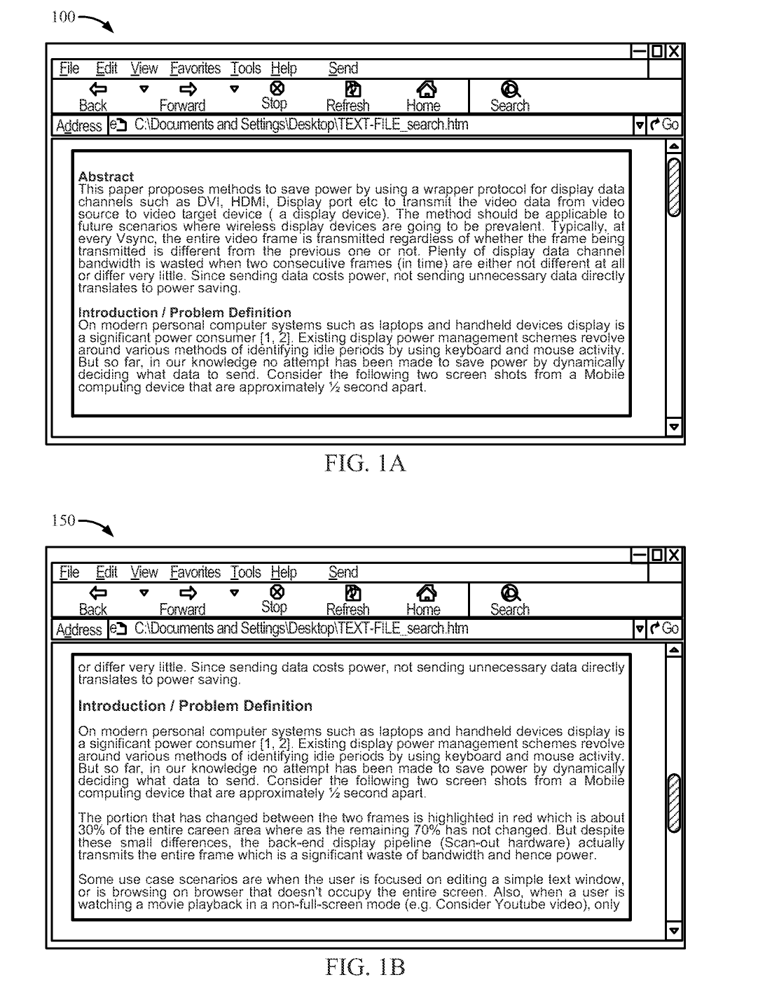

FIGS. 1A-1B depict exemplary subsequent video frames 100, 150 that are taken approximately one-half of a second apart. This is an example of a case where the user is typing a document When the contents of first video frame 100 and the second video frame 150 are compared, the portion that has changed between the two frames is about 30% of the entire screen area. The remaining 70% has not changed. As a further example, when a user is watching a movie playback in a non-full-screen mode (e.g., an on-line video), only the window containing the video changes in content, whereas the rest of the screen remains the same. Thus, the displayed video has temporal redundancy. With recorded video, video compression schemes can exploit this temporal redundancy. In an exemplary case of video displays, the temporal redundancy can be exploited to save display data channel bandwidth as well as to conserve power, as a digital video link (wired or wireless) consumes a significant amount of power.

Exemplary methods and apparatus described herein leverage the temporal redundancy by transmitting only the difference in video pixel data between two consecutive video frames, instead of transmitting a full frame. A “full frame” is a video frame according to what backend timing dictates to be sent. For example, if backend timing (e.g., video input to a transmitter and/or video source device) has a resolution of 1920×1080 (i.e., 1080p) at 60 Hz, then video pixel data for a full frame of video including 2,073,600×24 bits (assuming 24 bits used to represent color of a pixel) of pixel information is sent every 1/60 seconds to a receiver (i.e., a target device).

As used herein, a “partial frame” is a difference between two temporally consecutive video frames such that the current frame can be constructed using the last frame and a current partial frame. A pixel that has changed value (in any of its components) from last frame to current frame is referred to as a “dirty pixel.”

A “macro-block” of pixels is a predefined square grid of pixels that is smaller than the frame, For example, a 4×4 macro-block can be defined as a collection of 16 pixels arranged in a square grid with each side made up of 4 pixels. Thus, a fall video frame of resolution 1920×1080 pixels has (1920×1080)/(4×4) 129,600 macro-blocks. A “dirty macro-block” is a macro-block with at least one dirty pixel.

With the above definitions in place, a “partial video frame” is a collection of dirty macro-blocks of predefined size between two temporally consecutive frames. Note that one may define a 1×1 macro-block, in which case a macro-block is a single pixel.

Partial video frames can be represented in several different ways, depending on factors such as the size of macro-block. the average amount of data likely to be transmitted in a normal use case, etc. One way to represent a partial video flame is to define a macro-block to be of size 1×1 pixel, which basically means that a pixel by pixel comparison of the two frames is performed, dirty pixels are identified, a location and/or index of the dirty pixels is determined, and the dirty pixels are merged into clusters and/or groups of dirty pixels so that only the start and end coordinate and/or index of a cluster and/or group need be transmitted. The additional information such as a number of such clusters, cluster length, and location, etc. can be referred to as metadata. A method to construct such clusters is presented herein.

Given a representation of a partial frame and the format of the metadata, a data transmission protocol can be built between a transmitter and a receiver. Finding a difference between two frames is a key activity involved in aspects of the disclosed methods. A simple and direct approach is to compare corresponding pixels of two consecutive frames. However, with large video frames such methods of representing partial video frames quickly leads to prohibitive computational overhead so macro-blocks of larger sizes such as 4×4 pixels or larger are considered. Representations and methods of working partial frame comprising of larger macro-blocks provided. When larger macro-blocks are used instead of single pixels, only one representative pixel out of the macro-block need be used to determine if the macro-block is dirty. When such representation is used, a partial frame is defined by a collection of single bit flags, with one bit per macro-block to indicate whether or not the particular macro-block is dirty. For example, consider a 1920×1080 resolution video frame. if 4×4 macro-blocks are considered, then a rectangular grid of 480×270 single bit flags for each corresponding macro-block is needed. This is the metadata that need to be transmitted before transmitting the dirty macro-blocks comprising the partial video frame. Note that the metadata in this example takes up about a 16,200 bytes of space. All these factors must be taken into account while deciding an optimal macro-block size for a particular application.

A receiver can re-construct the second of the two video frames into a full frame by copying over those pixels and/or macro-blocks that have changed from the last frame. In other words, the new data (e.g., dirty pixel data) replaces the old data in the receiver buffer. Note that the receiver is buffering the frame in a display device with a digital interface. The receiving device buffers the entire frame data received from the transmitting side and displays it. In conventional devices, at every VSync signal, the conventional device typically replaces an entire frame with a new frame received without bothering about how different the new frame is from the old frame (which is already there in the buffer). However, the present techniques enable a receiver to modify only the part of data in the buffer which has actually changed since a prior frame.

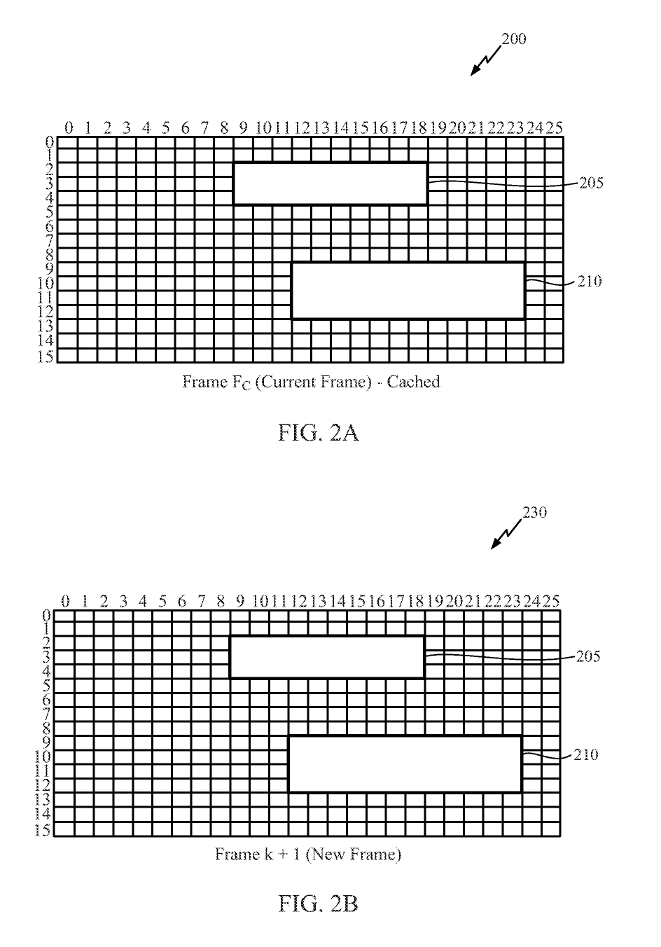

FIGS. 2A-2B depict exemplary video pixel data. FIG. 2A depicts full frame video pixel data for an initial video frame (“Fc”) 200. The example of FIGS. 2A-2B focuses on values of pixel data in a first region 205 and a second region 210. At the receiver, pixel data exists for the initial frame 200 in the frame areas outside of the first region 205 and the second region 210, and the data inside the first region 205 and the second region 210 is what has changed in the subsequent frame.

FIG. 2B depicts full frame video pixel data for a subsequent video frame (“k+1”) 230. In the first region 205 and the second region 210 of the subsequent video frame 230, the video pixel data is different from the video pixel data in the first region 205 and the second region 210 of the initial video frame 200. Thus, in the subsequent video frame 230, the first region 205 and the second region 210 include dirty pixels.

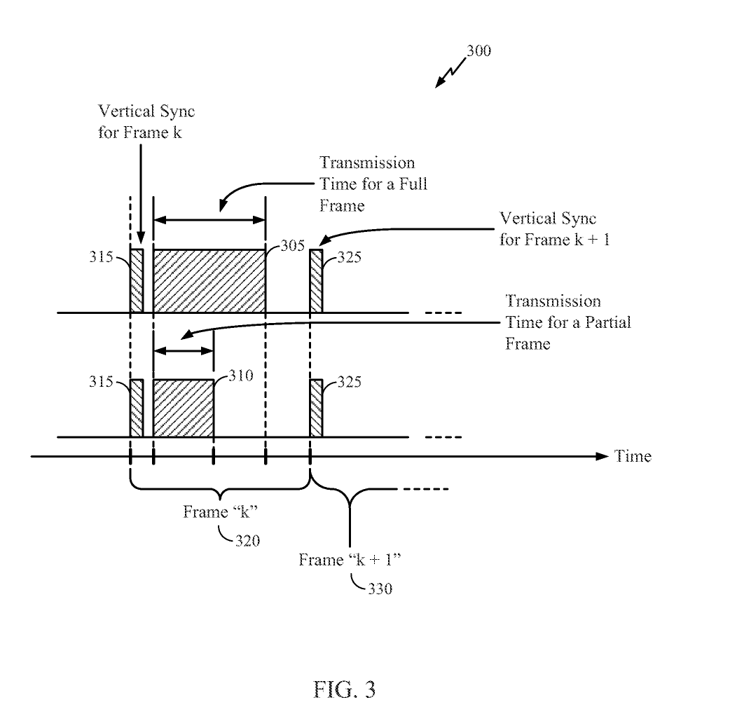

FIG. 3 depicts the time 300 for which a transmitter has to stay “ON” when transmitting video data. When the transmitter has more video data to send, it needs to stay on for a longer duration than when it has less data to send. Thus, when only data pertaining to changed pixels is transmitted, the transmitter can be turned “OFF” early to save power. Both a full frame video data signal 305 and a partial frame video data signal 310 are timed by periodic vertical synchronization pulses (Vsync). In FIG. 3, a first Vsync pulse 315 is for an initial video frame (“k”) 320 and a second Vsync pulse 325 is for a subsequent video frame (“k+1”) 330. A time between the leading edges of the sync pulses equals an inverse of a refresh rate of the initial video frame 320 and the subsequent video frame 330.

The upper chart depicts the full frame video data signal 305, the area of which is a function of the energy of the full frame video data signal 305. The lower chart depicts the partial frame video data signal 310, the area of which is a function of the energy of the partial frame video data signal 310. Transmitting the partial frame video data signal 310 takes significantly less transmission time and energy than sending the full frame video data signal 305. Further, transmitting a bit of information costs an order of magnitude more power than storing the same bit of information or doing some operations with it. This, power savings can also be derived by turning off scan out circuitry after transmitting the partial frame video data signal 310. Further, if there are no dirty pixels (e.g., a user reading a static document or looking at a static picture), then neither the full frame video data signal 305 nor the partial frame video data signal 310 is transmitted. Rather, a self-update signal is transmitted to tell the receiver to continue to display whatever is currently being displayed from its buffer.

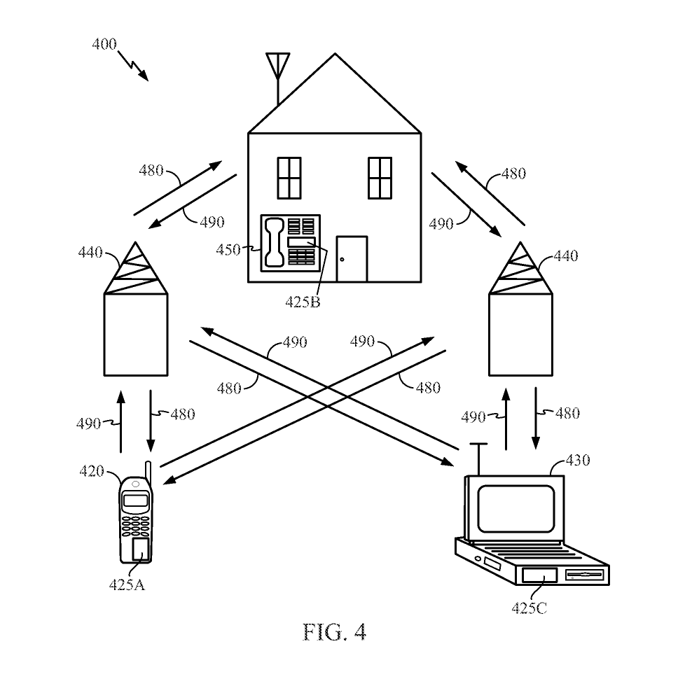

FIG. 4 depicts an exemplary communication system 400 in which an embodiment of the disclosure may be advantageously employed, For purposes of illustration, FIG. 4 shows three remote units 420, 430, and 450 and two base stations 440. The wireless communication system 400 can have many more remote units and more base stations. The remote units 420, 430, and 450 include at least a part of an embodiment 425A-C of the disclosure as discussed further herein. FIG. 4 also shows forward link signals 480 from the base stations 440 and the remote units 420, 430, and 150, as well as reverse link signals 490 from the remote units 420, 430, and 450 to the base stations 440.

In FIG. 4, the remote unit 420 is shown as a mobile telephone, the remote unit 430 is shown as a portable computer, and the remote unit 450 is shown as a fixed location remote unit in a wireless local loop system. In examples, the remote units 430 may be a mobile phone, a hand-held personal communication systems (PCS) unit, a portable data unit such as a personal data assistants, a GPS-enabled device, a navigation device, a settop box, a music player, a mobile device, a video player, an entertainment units, or any other device that stores or retrieves data or computer instructions, or any combination thereof. Although FIG. 4 illustrates remote units according to the teachings of the disclosure, the disclosure is not limited to these exemplary illustrated units. Embodiments of the disclosure may be suitably employed in any device which includes active integrated, circuitry including memory and on-chip circuitry for test and characterization.

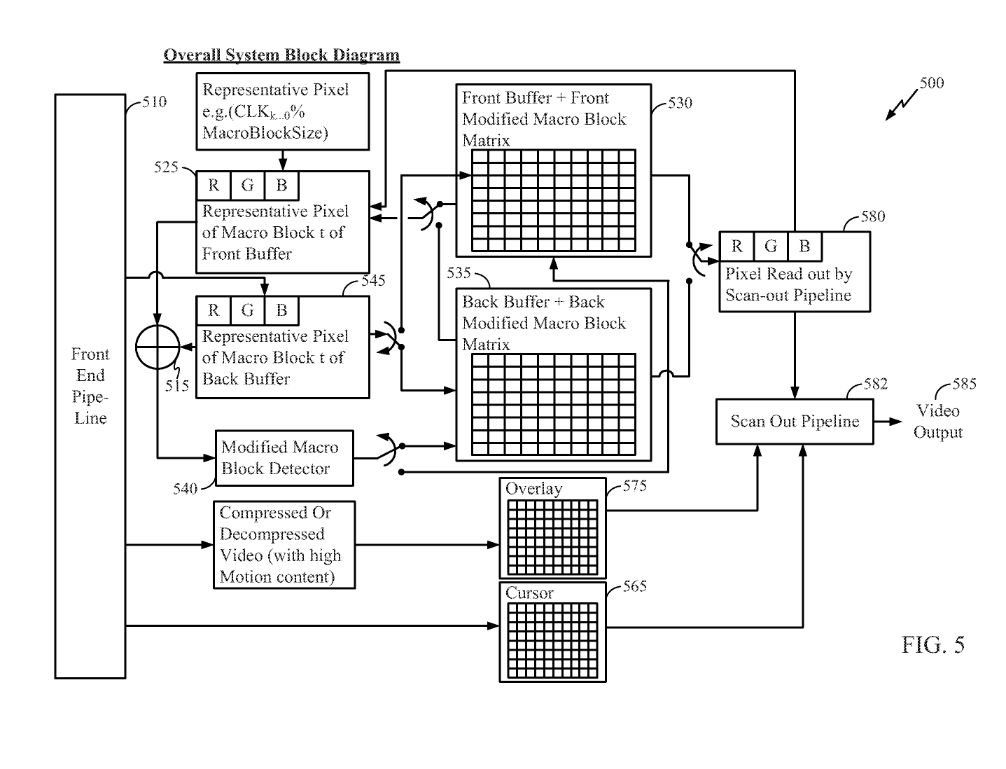

FIG. 5 depicts an exemplary video source device 500 for processing a partial frame, such as a video transmitter. An input video signal including video pixel data (i.e., a raw video signal) is received at a front end pipeline 510 (i.e., an interface). FIG. 5 depicts an exemplary RGB signal as the received video signal; however, other video formats can also be processed by the video source device 500. In the exemplary video source device 500, a graphics sub-system works with two main frame buffers (Front buffer 530 and Back buffer 535) in a ping-pong fashion, where Front buffer 530 is the one being currently read out by a Scan out pipeline 580 and the back buffer 535 is the one that is currently being written to by the front end pipeline 510. In addition, video with high motion content is buffered into an overlay buffer 575. Also there is a separate small buffer 565 for mouse pointer or cursor called hardware cursor, though implementation can be adapted to work without the hardware cursor.

The video source device 500 also includes a dirty pixel macro-block detector 540 that receives the output from a Modulo-2 adder 515. The Modulo-2 adder 515 receives an input including a representative pixel of a macro block from the front buffer 525. The dirty pixel macro-block detector 540 employs an algorithm to compare consecutive pixels and determine if one of the consecutive pixels is zero while the other consecutive pixel is non-zero. For example, if an i^{th} pixel 545 is zero and an (i+1)^{th} pixel is non-zero, this result implies that the (i+1)^{th} pixel is at a beginning of a block (i.e., a matrix) of dirty pixels. Conversely, if (i+1)^{th} pixel is non-zero and OP pixel 545 is zero, this result implies that the (i+1)^{th} pixel is at an end of a block of dirty pixels. As the dirty pixels are identified, the respective location of the dirty macro-blocks is recorded in the front buffer 530. In an example, when there are very few non-dirty pixels located between two dirty blocks, the dirty blocks can be merged into one dirty macro-block. The basic step here is detecting a dirty macro-block. Note that a macro-block can be defined to be just 1×1, in which case it is just a single pixel. So pixel-by-pixel comparison is a special case of macro-block by macro-block comparison. The reason macro-block comparison is performed instead, of pixel comparison to reduce the computational overhead of doing pixel by pixel comparison. The size of macro-block is left as a design parameter that can be changed according to needs of the implementation.

The following algorithm describes an exemplary method to construct a partial video frame at the video source device 500. It is possible to apply this algorithm to the grid and/or a matrix of flags indicating dirty macro-blocks. When applied for this purpose, the contiguous dirty flags can be detected and thereby help transmit a group of dirty macro-blocks. So in this algorithm, the key-word “macro-block” is used, instead of the term “pixel.” For each macro-block, the corresponding one-bit flag in the above matrix is compared, The algorithm is as follows:

For each macro-block i
{
Step 1: If ith flag (of dirty macro-block flag matrix) is zero set flag1 = true
else flag1 = false.
Step 2: If (i+1)th flag (of dirty macro-block flag matrix) is zero set flag1 =
true else flag1 = false.
Step 3: If flag1 is true and flag2 is false then set new dirty block
beginning.
{

Merge: If((i+1 − End[k]) > Threshold)

{

SetStart[k++] = i+1;

}

}
Step 4: If flag1 is false and flag2 is true then set new dirty block end.

Set End[k] = i;

Step 5: Now write the start coordinate of the macro-block corresponding to
the Start[k] flag and the end coordinate of the macro-block corresponding
to the End[k] Flag to the next unused partial frame register.
}

Note that the extra step of merging macro-blocks into bigger contiguous blocks and noting down the start and end coordinates of these larger blocks in partial-frame registers, is an additional step that might further optimize the process. But this is not absolutely necessary to implement the overall general idea. This might be suitable only when the flag matrix itself is too large to be transmitted.

A partial frame is prepared by gathering information about the dirty macro-blocks and by appending metadata. The metadata can include a dirty macro-block matrix, which is a matrix of dirty flags indicating whether or not a corresponding macro-block is dirty. As a further example, Table One provides another example of the appended metadata:

TABLE ONE

| Programmable Threshold | # of Dirty Blocks |
|---|---|
| Block 0 Start Index | Block 0 End Index |
| Block 1 Start Index | Block 1 End Index |
| . | . |
| . | . |
| . | . |
| Block N Start index | Block N End Index |

Also, if cursor pointer video data from the small buffer 565, mouse pointer video data from a mouse pointer video circuit, and/or overlay video data from the overlay buffer 575 is rendered into the hardware cursor, the cursor pointer video data, the mouse pointer video data, and/or the overlay video data become dirty blocks in the final partial frame. In the case of the mouse pointer video data, typically only a location of the mouse pointer changes, not a shape and size of the mouse pointer, so in effect, a partial frame technique only transmits the location of the mouse pointer.

The process of comparing the video pixel data for the subsequent frame with the video pixel data for the subsequent frame can be performed in parallel with the dirty block detection process, since the video pixel data can be buffered and the whole process can be pipelined.

The following algorithm describes an exemplary method to construct a partial frame at a video source, such as the video source device 500. After the macro-block has been written to the back buffer or while the macro-block is being written to the back buffer to do the following:

For the macro-block that is currently being written
{
1. Obtain the index of the representative pixel
2. Read the value of the representative pixel from both back buffer and
front buffer
3. XOR the two values to determine if they are equal
4. Update the flag in the dirty macro-block matrix corresponding to the
current macro-block with a value of 1 if result of above operation in step 3
is non-zero, and value of 0 if the result of above operation in step 3 is
zero.
}

The scan out pipeline circuit 582 provides a video output 585 of the video source device 500 by reading out the dirty block and the associated metadata. The scan out pipeline circuit 582 transmits a partial frame and the metadata associated with the transmitted partial frame.

The video source device 500 can also include a circuit configured to communicate with an operating system to determine if there is video content in the current display as well as gathering metadata such as the location and size of any such window and a source thereof. These control functionality can be built into the device driver software for the graphics adapter and facilitated through few hardware registers and control circuitry.

Similarly, determining if the target display device possess video decompression capability can be easily implemented using few control messages that must be exchanged between the graphics adaptor and the display device during initialization of the display device, for example, when a system is powered on, when a display is driven for the first time, or when the system wakes up from some sleep mode, etc. Such exchange of control messages can be built into available digital display protocols such as DisplayPort or can be built on top of these protocols at the interface level.

From a bandwidth (and hence also power) point of view it is important to know if the target display device is capable of decompressing the video and compositing it into the existing display surface. Because when a target device possesses such de-compressing & compositing capability, this directly translates to transmission of compressed data. The source (of video) device need not waste power and bandwidth decompressing video, compositing it to the overall frame and recompressing it again.

Though approach of using a single representative pixel is described here to avoid infeasible computational overhead, on systems, where the display resolution is sufficiently small to allow such computation, it might be possible to work with individual pixels or macro blocks of smaller size, say 2×2 pixels. The description doesn't preclude such adjustment in implementation wherever it is feasible.

Some lower significant bits of clock value can be used in the description above to determine the index of a pixel that would represent the macro blocks under consideration at a given VSync processing. This is one way of introducing some randomness to this process of selecting a pixel to represent a macro-block. However, any other method. can also be adopted to compute the representative pixel.

When the current display contains video with high motion content that is windowed (non-Full screen mode), the effectiveness of the method depends of the video resolution and the size of the window, so a window size threshold may be established and Delta Frame Transmission may be turned off whenever, the window size is found. to he greater than this threshold. This threshold may be statically or dynamically computed.

The target device can have basic compositing capability (similar to that of a back end pipeline compositor), so that when presented with few surfaces (such as modified macro blocks of main frame buffer, Overlay and Cursor) the target device can compose the desired display surface. Also, the target device needs to have basic buffering capability to store the last displayed frame and apply the received modified macro blocks.

It should be noted. that the only metadata regarding modified macro blocks that needs to be transmitted to the target display device is the “Modified Macro Block Matrix” (MMBM). In lieu of the MMBM, it is also possible to accomplish the same task by transmitting the indices of the modified. macro blocks. It is assumed that macro block size is pre-negotiated during the initialization time or is a fixed characteristic of a display adapter or a target device. When there is no modified macro block that need to be transmitted, a special signal may be sent to the target device to continue displaying the existing data.

It may be further noted that in case of mouse pointer, typically the location of the mouse pointer changes more often than the shape/size of the pointer. So, in effect Delta Frame Transmission will only transmit the location of the mouse pointer rather than the data unless the shape has actually changed. This can be easily adopted with a flag included in the control information that indicates whether to expect a new cursor or use the old cursor data at a new location.

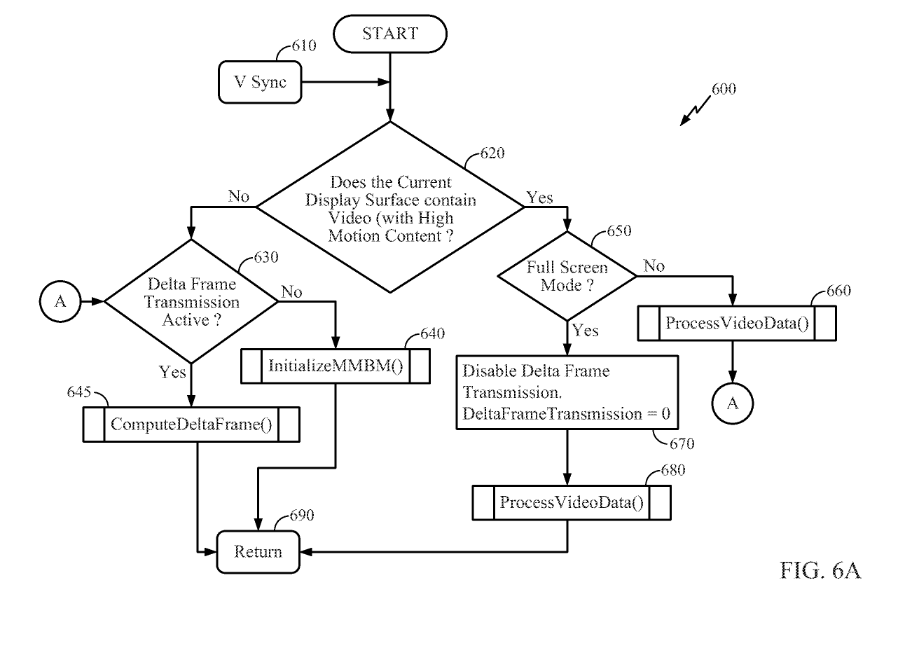

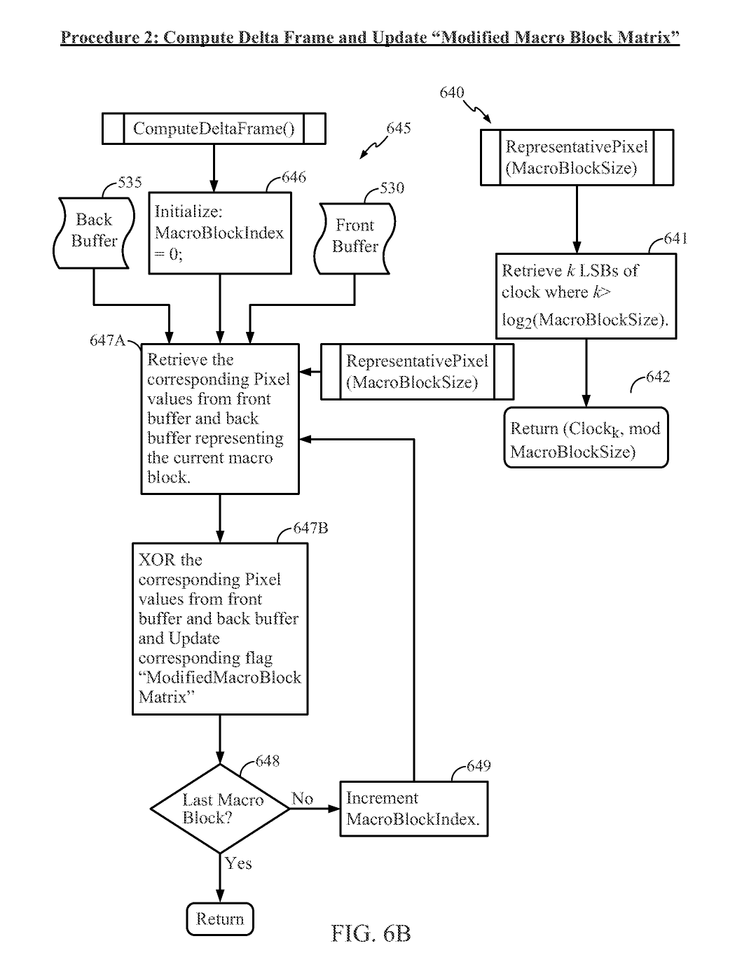

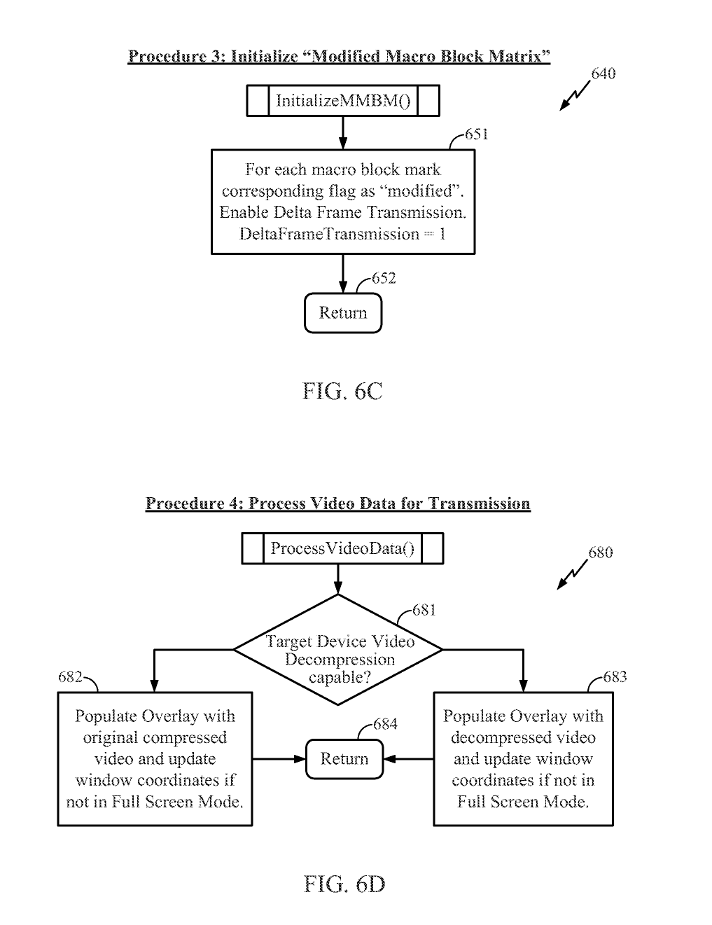

FIGS. 6A-D depict an exemplary method 600 for processing partial video frame data. The method for processing partial video frame data can be performed by the apparatus described hereby.

The exemplary method 600 includes a two phase approach. The first step in the first phase is to detect if a current display such as a desktop) contains any high motion content video such as a movie, news, game etc. that typically changes very fast over the entire window and might be going through video de-compression process. If there is no high motion content video, the exemplary method 600 can directly go to the second step and compute the frame difference. If the display contains high motion content video, the exemplary method 600 needs to determine if the high motion content video occupies the fall screen. If yes, then the exemplary method 600 transmits the compressed high motion content video itself to the target if the target is capable of decompressing the video. The exemplary method 600 can transmit the compressed high motion content video itself whenever available, e.g., a YouTube video and/or news broadcast etc. as obtained, from the internet. Games that are rendered on a computer are not compressed and can be handled conventionally. Otherwise, the exemplary method 600 falls back to the conventional method of transmitting a complete video frame as generated by a video codec. If the video doesn't occupy the entire screen, then the exemplary method 600 needs to route the video content to a video overlay buffer (either compressed or uncompressed) and consider only those portions of the display surface that are outside the window containing video, for computing the frame difference.

Determining if there is high motion content video content currently being played requires invoking operating system or similar software playing a role of an operating system. Subsystems of an operating system such as a desktop window manager or task manager that is aware of all the applications that currently share the display surface can be queried to know if there is any video content being played/rendered on to the display surface. If yes, information about the window size, location (in pixel coordinates), full screen mode etc. about the video can be determined from operating system modules with the functionality of a desktop window manager. Determining if the current display contains high motion content video is straightforward if the video is being output by a locally resident media player with a video decoder. Since video can also be played from a web browser, such software modules, if active, must also be queried in the same fashion. The overall task can be accomplished by a program that is bundled with the operating system or similar software and that provides information such as whether or not the current desktop contains video, and if so, whether it is in full screen mode, or non-full screen mode, the coordinates of the window(s) containing the video etc. This program also takes control input in order to deliver video in original format if it is determined that the target display device is capable of decompressing and compositing the video.

The objective of the second phase is to compute the frame difference, once the video fragment with high motion content is separated out. As discussed before, pixel by pixel comparison is not practical because of high cost of computation as well as memory transaction. To reduce both, consider the following observation. When there is some change in the content of a display in the use cases discussed earlier, granularity of this change is never at the level of a pixel. To appreciate this fact, consider the change of content due to movement of the mouse pointer. Typically a mouse pointer occupies a 64×64 pixel block, so when mouse pointer changes position, there is a content change in the granularity which is 64×64 pixels. Similarly, in the scenario where a user is entering text into an editor, the granularity is that of the size of a character. So even from a conservative standpoint, if only one pixel or a small subset of pixels from a reasonably small macro-block is considered, it will be possible to determine the changes with high level of accuracy. This method can be used. to determine frame difference.

For example: a 15 inch display with resolution 1920×1080 pixels with aspect ratio of 4:3. Simple calculation tells us that the screen is 12 inch in length and 9 inch in height and hence the dimension of a single pixel is about (12/1920=0.00625) inch in length and (9/1080 =0.00833) inch in height. Such dimensions imply that any change in display is very likely to affect group of pixels rather than a single pixel.

Instead of trying to find a frame difference by a pixel-by-pixel comparison, the entire screen is divided into macro blocks of size 4×4 pixels and only one pixel out of the 16 pixels in the macro block is chosen to decide whether or not two corresponding macro blocks from two temporally consecutive frames are different. This is expected to work because, as discussed in the preceding paragraphs, granularity of change between consecutive frames is much higher than single pixels. Though less likely, it might happen that the pixel selected to represent a given macro block has not changed, whereas the macro block has changed. To address this, the representative pixel for a macro-block is changed on every VSync interrupt in pseudo-random fashion. This way, if a macro block has actually changed, all the pixels in the macro block will be examined in a span of 16 VSync interrupts, which is equivalent to (16/60) seconds with a 60 Hz refresh rate. This way, a change is detected in a macro block if the rate of change in the display content is slower than (60/16) ˜4 Hz. As the video with high motion content is separated in phase one, the rate of change of display content is expected to be well within this range. Consider the typing speed of an average computer user to appreciate this fact. The technique can be made more robust by picking a randomly different pixel to represent the macro block. A random index generator that will shuffle the order of the 16 pixels (that will be considered to represent the macro block) can be easily implemented in hardware.

The other overhead is that of memory read. Current systems do access the entire memory for transmitting the frame, but to avoid reading the same pixel again and again, start with the macro blocks that were determined to modified in the last iteration, which have to be read out of memory anyway to be transmitted. So a single read access for the purpose of transmitting the macro block, should also provide data to the comparator. Once all the modified macro blocks are compared, the macro blocks that were deemed unmodified in the last iteration are compared. Note that while comparing the macro blocks that were deemed unmodified in the last iteration (last VSync interrupt processing), don't read the whole macro block, but only the pixel that is currently designated to represent the macro block. Hardware may be optimized to facilitate such access patterns easily.

So, when combined computation is reduced, as is memory access over head by a factor equal to the size of a macro block. It should be noted that the overhead for extra memory is very minimal in this approach because only a bit is needed to label a macro block as modified (1) or un-modified (0). In the above example, the extra memory needed is about (1920×1080)/(4×4)=129,600 bits =16,200 bytes.

FIG. 6A depicts an overview of the method 600. The method 600 can be timed at step 610 with a vertical sync pulse. At step 620, a decision is made as to the presence of video with high motion content. At step 630, a decision is made as to the presence of an active delta frame transmission. At step 640, a modified macro-block matrix (MMBM) is initialized. At step 645, a delta frame is computed. At step 650, presence of a full screen mode is detected. At step 660, video data is processed. At step 670, delta frame transmission is disabled for video data processing in step 680. At step 690, the process 600 repeats.

FIG. 6B depicts updating the modified macro-block matrix 640 and computing a delta frame 645. The modified macro-block matrix 640 is updated by retrieving k least significant bits (LSBs) of a clock at step 641. At step 642, the updating process returns to step 690.

The delta frame is computed at 645 as follows. In step 646, a macro-block index is initialized to zero. In steps 647A-B, corresponding pixel values from the front and back buffers representing the current macro-block are retrieved. The corresponding pixel values are then XORed and the corresponding flag of the ModifiedMacroBlock Matrix is updated. In step 648, a determination is made as to whether the current macro block is the last macro-block to be processed. If not, then the macro-block index is incremented at step 649. If so, then the delta frame computation process 645 returns to step 690.

FIG. 6C depicts an example of initializing the modified macro-block matrix 640. In step 651, for each macro-block, a corresponding flag is marked as modified and delta frame transmission is enabled. A DeltaFrameTransission flag is set to 1. At step 652, the updating process returns to step 690.

FIG. 6D depicts processing video data for transmission 680. At step 681, a determination is made as to the capability of the target device to decompress video. At step 682, an overlay is populated with original compressed video, and window coordinates are updated if the target device is not in fall screen mode. In some circumstances, it is de-compressing and subsequent re-compressing is inefficient, and it is better to transmit the video in its original compressed format. At step 683, an overlay is populated with decompressed original video, and window coordinates are updated if the target device is not in full screen mode. At step 684, the processing video data for transmission 680 returns to step 690.

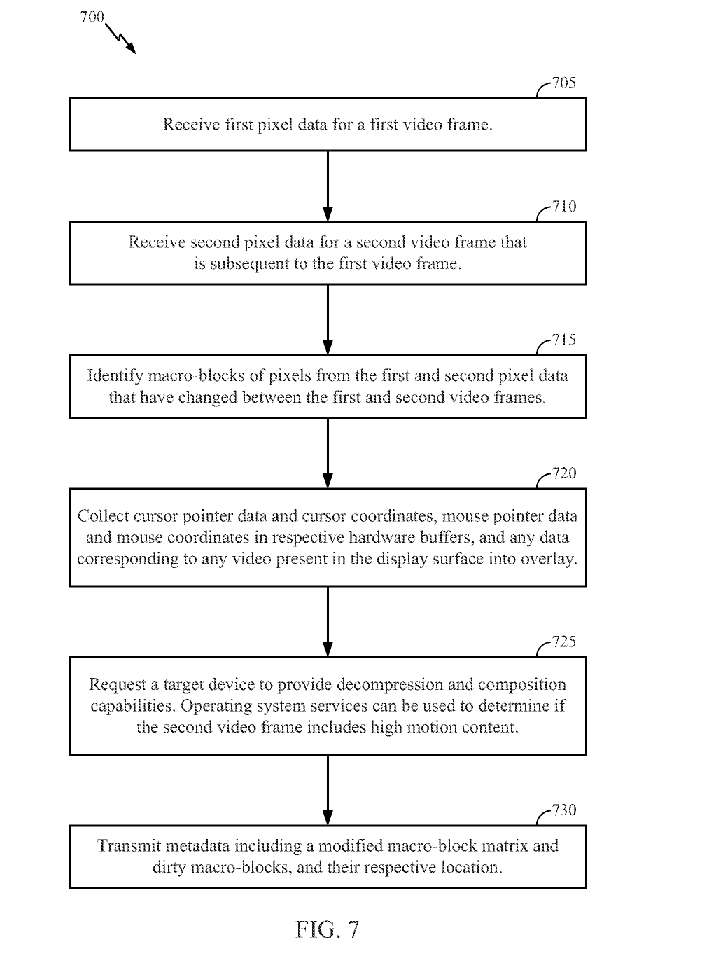

FIG. 7 depicts an exemplary method 700 for processing partial video frame data. The method for processing partial video frame data can be performed by the apparatus described hereby, such as the video source device 500.

In step 705, first pixel data for a first video frame is received.

In step 710, second pixel data for a second video frame that is subsequent to the first video frame is received.

In step 715, macro-blocks of pixels from the first and second pixel data that have changed between the first and second video frames are identified. Dirty macro-blocks can be determined by comparing representative pixel(s) of corresponding macro-blocks or any other efficient method.

In step 720, cursor pointer data and cursor coordinates, mouse pointer data and mouse coordinates is collected in respective hardware buffers, and any data corresponding to any video present in the display surface into overlay. Note that in these components of the surface, the exemplary method 700 doesn't compute any difference. For cursor and mouse pointer the exemplary method 700 collects the location and shape and/or size of the cursor and/or mouse pointer. For the video, the exemplary method 700 collects the compressed video directly and location of the video on display surface. It is important to highlight that the exemplary method 700 is not going through the usual process of decompressing the video (as obtained from internet or elsewhere) and merging it (called compositing) to the final display surface. The exemplary method 700 transmits the compressed video itself because that way there will be less data to be transmitted. The receiving device (target display device) will de-compress the video and composite the final display surface. Video de-compression and composition capabilities can be built into target devices.

In step 725, a target device is requested to provide decompression and composition capabilities. Operating system services can be used to determine if the second video frame includes high motion content.

In step 730, the macro-blocks which are determined as ‘dirty’ and their respective pixel locations are transmitted to the video receiver. Before transmitting the dirty macro-blocks, meta data containing the Modified Macro-Block Matrix (MMBM), as described. in previous paragraphs, is transmitted.

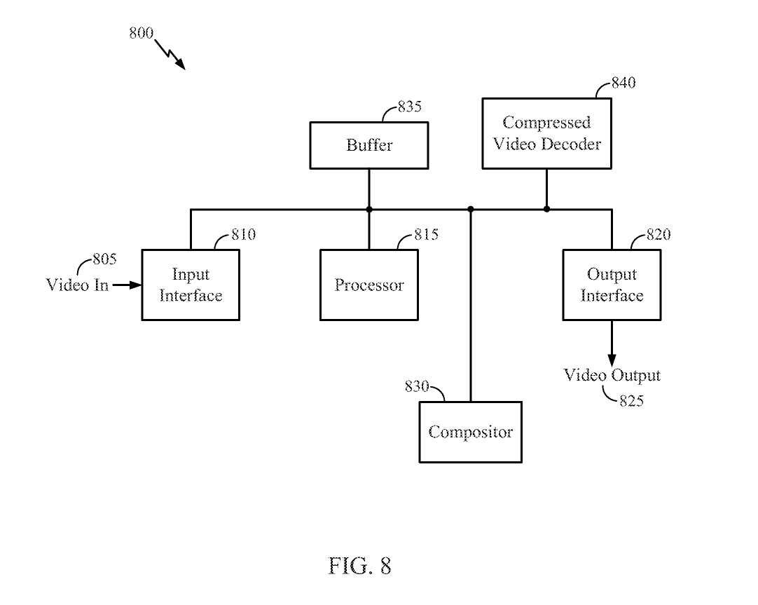

FIG. 8 depicts an exemplary video target device 800 for processing a partial frame, such as a video receiver. An input video signal 805 including video pixel data for a partial frame is received at an interface 810. In an example, the input video signal 805 is the video output 585 including a changed (i.e., dirty) macro-block which comprises: 1. Meta data such as Modified Macro-block matrix, and 2. The dirty macro blocks. A processor 815 reads a bit in the metadata in the input video signal 805 indicating whether an incoming frame in the input video signal 805 is a full frame or a partial frame. If the incoming frame is a full frame, the output interface 820 outputs the video pixel data for the full frame directly as a video output 825. Otherwise, if the incoming frame is a partial frame, then the processor 815 reconstructs a full flame with a compositor 830 using the video pixel data for the incoming partial frame with video pixel data for a prior full frame retrieved from the buffer 835. At the receiver, re-compositing the complete frame involves process of pasting the dirty blocks on to the currently displayed frame at proper locations. The index of a dirty macro-block uniquely identifies its position in the complete video frame. Since the data transmitted 580 in a predefined order (e.g. row-major order) contains only the dirty macro-blocks, the processor at the receiver collects the dirty macro-blocks and overwrites the currently displayed frame in the frame buffer.

The receiver can receive compressed video (video with high motion content). When the receiver gets compressed video, the receiver needs to first de-compress the video with a compressed video decoder 840 before doing the composition, i.e. before pasting this onto the currently displayed frame. The video pixel data for the incoming partial frame is added to the video pixel data for the prior full frame for respective pixel locations identified in the metadata. In examples, the pixel locations for which the addition occurs can be identified by pixel number. In examples, the pixel locations for which the addition occurs can be identified by block coordinates (i.e., matrix coordinates), such as start and. stop coordinates.

The resultant video pixel data for the full frame is forwarded to the output interface 820 and stored in the buffer 835. The output interface 820 forwards the video output 825, for example, to a display controller which drives a display surface (i.e., a video screen).

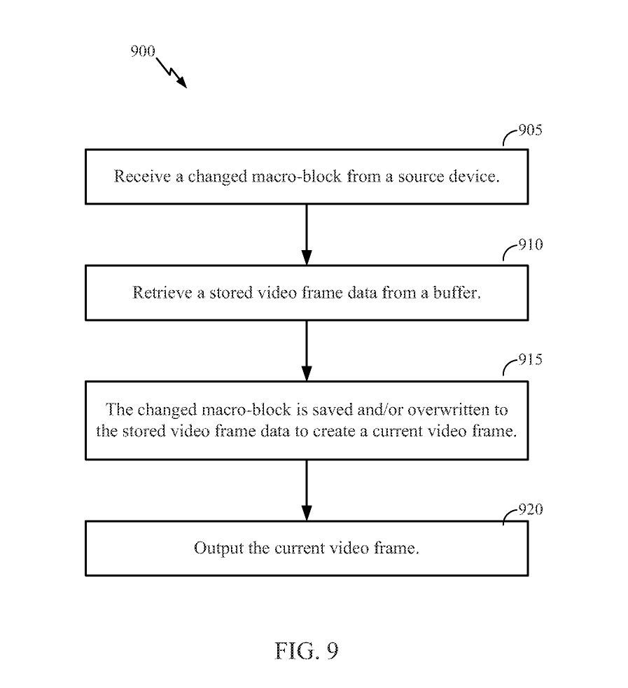

FIG. 9 depicts an exemplary method 900 for processing partial video frame data. The method for processing partial video frame data can be performed by the apparatus described hereby, such as the video target device 800.

In step 905, a changed macro-block is received from a source device.

In step 910, stored video frame data is retrieved, from a buffer.

In step 915, the changed macro-block is saved andlor overwritten to the stored video frame data to create a current video frame,

In step 920, the current video frame is output.

Those of skill in the art will appreciate that information and signals may be represented. using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In some aspects, the techniques herein can be employed in a multiple-access system capable of supporting communication with multiple users by sharing the available system resources (e.g., by specifying one or more of bandwidth, transmit power, coding, interleaving, and so on). For example, the techniques herein can be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein can be designed to implement one or more standards, such as IS-95, cdma2000, IS-856, W-CDMA, TDSCDMA, and other standards. A CDMA network can implement a radio technology such as Universal Terrestrial Radio Access (UTRA), cdma2000, or some other technology. UTRA includes W-CDMA and Low Chip Rate (LCR). The cdma2000 technology covers IS-2000. IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802,20, Flash-OFDM.RTM., etc, UTRA, E-UTRA, and GSM are part of Universal Mobile Telecommunication System (UMTS). The teachings herein can be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure can be described using 3GPP terminology, it is to be understood that the teachings herein can be applied to 3GPP (e.g., Re199, Re15, Re16, Re17) technology, as well as 3GPP2 (e.g., 1xRTT, 1xEV-DO RelO, RevA, RevB) technology and other technologies. The techniques can be used in emerging and future networks and interfaces, including Long Term Evolution (LTE).

At least a portion of the methods, sequences and/or algorithms described in connection with the embodiments disclosed herein may be embodied directly in hardware, in a software module executed by a processor, or in a combination of the two. In an example, a processor includes multiple discrete hardware components. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Further, many embodiments are described in terms of sequences of actions to be performed by, for example, elements of a computing device. It will be recognized that various actions described herein can be performed by a specific circuit (e.g., application an specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, a corresponding circuit of any such embodiments may be described herein as, for example, “logic configured to” perform a described action.

An embodiment of the invention can include a computer readable media embodying a method described herein. Accordingly, the invention is not limited to illustrated. examples and any means for performing the functionality described herein are included in embodiments of the invention.

The disclosed apparatus and methods can be designed and can be configured in a computer file (e.g., a GDSII and/or a GERBER file) that is stored, on a computer readable media. This file is in turn provided to a fabrication handler who fabricates a device, based on the file, with a lithographic device. The resulting product is a semiconductor wafer that can be cut into semiconductor dies and packaged into semiconductor chips. The semiconductor chips can be employed in devices described. hereby. Accordingly, at least a part of the apparatus described hereby can be integrated on a semiconductor die.

Embodiments can include a machine-readable media and/or a computer-readable media embodying instructions which, when executed by a processor, transform a processor and any other cooperating devices into a machine for performing a function described. hereby.

Nothing that has been stated or illustrated is intended to cause a dedication of any component, step, feature, object, benefit, advantage, or equivalent to the public, regardless of whether it is recited in the claims. While this disclosure describes exemplary embodiments of the invention, it should be noted that various changes and modifications could be made herein without departing from the scope of the invention as defined by the appended claims.

What is claimed is:

1. A method, comprising:
receiving first pixel data for a first video frame;
receiving second pixel data for a second video frame that is subsequent to the first video frame;
identifying macro-blocks of pixels from the first and second pixel data that have changed between the first and second video frames; and
transmitting only the changed macro-blocks of pixels.

2. The method of claim 1, wherein multiple pixel locations in the first and second. pixel data have different pixel data values at respective pixel locations, and further including:
transmitting a matrix of one-bit flags that indicate which macro-blocks have changed since last frame and other meta-data to help a receiver reconstruct the second video flame.

3. The method of claim 1, further comprising compositing at least one of cursor pointer video data, mouse pointer video data, and overlay video data with the changed macro-blocks of pixels.

4. The method of claim 1, further comprising using operating system services to determine if the second video frame includes video with high motion content.

5. The method of claim 1, further comprising transmitting a portion of a display surface containing video with high motion content by not decompressing such video and transmitting it in original compressed form.

6. The method of claim 1, further comprising requesting a target device to provide decompression and composition capabilities.

7. An apparatus, comprising:
means for receiving first pixel data for a first video frame;
means for receiving second pixel data for a second video frame that is subsequent to the first video frame;
means for identifying macro-blocks of pixels from the first and second pixel data that have changed between the first and second video frames; and
means for transmitting only the changed macro-blocks of pixels.

8. The apparatus of claim 7, wherein multiple pixel locations in the first and second pixel data have different pixel data values at respective pixel locations, and further including:
means for transmitting a matrix of one-bit flags that indicate which macro-blocks have changed since last frame and other meta-data as required to re-construct the second video frame.

9. The apparatus of claim 7, further comprising means for compositing at least one of cursor pointer video data, mouse pointer video data, and overlay video data with the changed macro-blocks of pixels.

10. The apparatus of claim 7, further comprising means for using operating system services to determine if the second video frame includes video with high motion content.

11. The apparatus of claim 7, further comprising means for separating and transmitting a portion of a display surface containing video with high motion content by not decompressing such video and transmitting it in original compressed form.

12. The apparatus of claim 7, further comprising means for requesting a target device to provide decompression and composition capabilities.

13. The apparatus of claim 7, wherein the apparatus is integrated with at least one of an HDMI-compatible device, a Display compatible device, a mobile device, a set-top box, a television, a computer, a computer video card, a game console, DVD player, a satellite receiver, a monitor, a display headset, a video repeater, a video camera, a home theatre receiver, and a video switching device.

14. The apparatus of claim 7, further including a semiconductor die upon which at least a part of the apparatus is integrated.

15. An apparatus configured to save power, comprising a processor configured to:
receive first pixel data for a first video frame;
receive second pixel data for a second video frame that is subsequent to the first video frame;
identify macro-blocks of pixels from the first and second pixel data that have changed between the first and second video frames; and
transmit only the changed macro-blocks of pixels.

16. The apparatus of claim 15, wherein multiple pixel locations in the first and second pixel data have different pixel data values at respective pixel locations, and the processor is further configured to:
transmit a matrix of one-bit flags that indicate which macro-blocks have change since last frame and other meta-data required to re-construct the frame.

17. The apparatus of claim 15, wherein the processor is further configured to composite at least one of cursor pointer video data, mouse pointer video data, and overlay video data with the changed macro-blocks of pixels.

18. The apparatus of claim 15, wherein the processor is further configured to use operating system services to determine if the second video frame includes video with high motion content.

19. The apparatus of claim 15, wherein the processor is further configured to transmit a portion of a display surface including high motion content by not decompressing the second video frame and transmitting the second video frame.

20. The apparatus of claim 15. wherein the processor is farther configured to request a target device to provide decompression and composition capabilities.

21. The apparatus of claim 15, wherein the apparatus is integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

22. The apparatus of claim 15, further including a semiconductor die upon which at least a part of the apparatus is integrated.

23. A non-transitory computer-readable medium, comprising instructions stored thereon that, if executed by a processor, cause the processor to execute a method comprising:
receiving first pixel data for a first video frame;
receiving second pixel data for a second video frame that is subsequent to the first video frame;
identifying macro-blocks of pixels from the first and second pixel data that have changed between the first and second video frames; and
transmitting only the changed macro-blocks of pixels.

24. The non-transitory computer-readable medium of claim 23, wherein multiple pixel locations in the first and second pixel data have different pixel data values at respective pixel locations, and the method further includes:
transmitting a matrix of one-bit flags that indicate which macro-blocks have changed since last frame and other meta-data required to re-construct the second video frame.

25. The non-transitory computer-readable medium of claim 23, wherein the method further comprises compositing at least one of cursor pointer video data, mouse pointer video data, and overlay video data with the changed macro-blocks of pixels.

26. The non-transitory computer-readable medium of claim 23, wherein the method further comprises using operating system services to determine if the second video frame includes video with high motion content.

27. The non-transitory computer-readable medium of claim 23, wherein the method further comprises separating and transmitting a portion of a display surface containing video with high motion content by not decompressing such video and transmitting it in its original compressed form.

28. The non-transitory computer-readable medium of claim 23, wherein the method further comprises requesting a target device to provide decompression and composition capabilities.

29. The non-transitory computer-readable medium of claim 23, wherein the computer-readable medium is integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

30. A method, comprising:
receiving a changed macro-block from a source device;
retrieving stored video frame data from a buffer;
overwriting the stored video frame data with the changed macro-block to create a current video frame; and
outputting the current video frame.

31. An apparatus, comprising:
means for receiving a changed macro-block from a source device;
means for retrieving stored video frame data from a buffer;
means for overwriting the stored video frame data with the changed macro-block to create a current video frame; and
means for outputting the current video frame.

32. The apparatus of claim 31, wherein the apparatus is integrated with at least one of an HDMI-compatible deice, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

33. The apparatus of claim 31, farther including a semiconductor die upon which at least a part of the apparatus is integrated.

34. An apparatus configured to save power, comprising a processor configured to:
receive a changed macro-block from a source device;
retrieve stored video frame data from a buffer;
overwrite the stored video frame data with the changed macro-block to create a current video frame; and
output the current video frame.

35. The apparatus of claim 34, wherein the processor is integrated. with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

36. The apparatus of claim 34, further including a semiconductor die upon which at least a part of the apparatus is integrated.

37. A non-transitory computer-readable medium, comprising instructions stored thereon that, if executed by a processor, cause the processor to execute a method comprising:
receiving a changed macro-block from a source device;
retrieving stored video frame data from a buffer;
overwriting the stored video frame data with the changed macro-block to create a current video frame; and
outputting the current video frame.

38. The non-transitory computer-readable medium of claim 37, wherein the computer-readable medium is integrated with at least one of an HDMI-compatible device, a DisplayPort compatible device, a mobile device, a set-top box, a television, a computer, a computer video card, a game console, DVD player, a satellite receiver, a monitor, a display headset, a video repeater, a video camera, a home theatre receiver, and a video switching device.

39. A method, comprising:
steps for receiving first pixel data for a first video frame;
steps for receiving second pixel data for a second video frame that is subsequent to the first video frame;
steps for identifying macro-blocks of pixels from the first and second pixel data that have changed between the first and second video frames; and
steps for transmitting only the changed macro-blocks of pixels.

40. The method of claim 39, wherein multiple pixel locations in the first and second pixel data have different pixel data values at respective pixel locations, and further including:
steps for transmitting a matrix of one-bit flags that indicate which macro-blocks have changed since last frame and other meta-data to help a receiver reconstruct the second video frame.

41. The method of claim 39, further comprising steps for compositing at least one of cursor pointer video data, mouse pointer video data, and overlay video data with the changed macro-blocks of pixels.

42. The method of claim 39, further comprising steps for using operating system services to determine if the second video frame includes video with high motion content.

43. The method of claim 39, further comprising steps for transmitting a portion of a display surface containing video with high motion content by not decompressing such video and transmitting it in original compressed form.

44. The method of claim 39. further comprising steps for requesting a target device to provide decompression and composition capabilities.

45. A method, comprising:
steps for receiving a changed macro-block from a source device;
steps for retrieving stored video frame data from a buffer;
steps for overwriting the stored video frame data with the changed macro-block to create a current video frame; and
steps for outputting the current video frame.
